(19) United States
(12) Patent Application Publication
(10) Pub. No.: US 2008/0088545 A1
(43) Pub. Date: Apr. 17, 2008

(54) AMOLED PANEL DISPLAY SYSTEM WITH TEMPERATURE REGULATION AND CONTROLLING METHOD THEREOF

(75) Inventors: Chi-Wen Chen, Hsinchu (TW); Meng-Hsiang Chang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: AU OPTRONICS CORPORATION, Hsinchu (TW)

(21) Appl. No.: 11/847,344

(22) Filed: Aug. 30, 2007

(30) Foreign Application Priority Data
Oct. 11, 2006 (TW) 95137292

(51) Int. Cl. G09G 3/30

(52) U.S. Cl. 345/76

(57) ABSTRACT

An active matrix organic light emitting diode (AMOLED) panel is disclosed. The AMOLED panel comprises a pixel array, a temperature sensor and a feedback control circuit. The temperature sensor measures the temperature of the AMOLED panel. The feedback control circuit decides the driving current of the AMOLED panel according to the temperature of the AMOLED panel. Since the driving current is inversely proportional to the measured temperature of the AMOLED panel in the present invention, the possibility of subjecting the AMOLED to too high in a temperature and a current is avoided and the lifetime of the AMOLED can be increased.

### CROSS-REFERENCE TO RELATED APPLICATION

This application claims the priority benefit of Taiwan application serial no. 95137292, filed Oct. 11, 2006. All disclosure of the Taiwan application is incorporated herein by reference.

### BACKGROUND OF THE INVENTION

1. Field of the Invention

The present invention relates to an active matrix organic light emitting diode (AMOLED) panel, and more particularly to a method of regulating the temperature of a AMOLED panel by adjusting a driving current.

2. Description of Related Art

Organic light emitting diode (OLED) panel has a faster response, lighter weight, lesser viewing angle restrictions and greater contrast compared with a liquid crystal display panel. Therefore, in recent years, OLED is one of the principle focuses of research for display panels. According to the driving method, the OLED panel can be classified as a passive matrix organic light emitting diode (PMOLED) panel or an active matrix organic light emitting diode (AMOLED) panel. In general, the AMOLED panel is particularly adapted to the production of high resolution and large size display panels.

The brightness of a pixel in the AMOLED panel is proportional to the conducting current of the organic light emitting diode and the size of the conducting current is decided by the transistor. When the temperature of the AMOLED panel continuously increases, the threshold voltage of the transistor is gradually lowered so that the current at the drain terminal of the transistor will increase. Because the anode of the light emitting diode and the drain terminal of the transistor are coupled together, the current passing through the organic light emitting diode will also increase. Since the AMOLED panel includes a considerable amount of organic material, the aging of the AMOLED panel is accelerated by the conditions of a high temperature and a high current. As a result, the lifetime of the display panel will be shortened.

FIG. 1 is a graph showing the variation of the driving current of a conventional display panel at different temperatures. As shown in FIG. 1, the driving current increases with the rise in temperature of the AMOLED panel. In other words, there is a direct proportion relationship of the driving current to the temperature of the AMOLED panel. This implies that the currents passing through the organic light emitting diodes are increased when the temperature of the AMOLED panel rises so that the aging of the AMOLED panel is accelerated and its lifetime is shortened.

### SUMMARY OF THE INVENTION

Accordingly, the present invention is to provide a flat panel display and its active matrix organic light emitting diode (AMOLED) panel is capable of regulating its driving current according to the variation of temperature in operation.

In addition, the present invention is to provide a method of controlling an AMOLED panel such that the driving current of the AMOLED panel is inversely proportional to the temperature.

To achieve these and other advantages and in accordance with the purpose of the invention, as embodied and broadly described herein, the invention provides an AMOLED panel comprising a pixel array, a temperature sensor and a feedback control circuit. The pixel array has a plurality of pixel units arranged to form an array and the temperature sensor is used for measuring the temperature of at least a portion of the pixel units. Thus, the feedback control circuit can adjust the driving current of the pixel array according to the temperature. In the present invention, the feedback control circuit is capable of controlling the driving current of the pixel array to be inversely proportional to the temperature measured by the temperature sensor.

According to another aspect of the present invention, a flat panel display comprising an AMOLED panel, a temperature sensor and a feedback control circuit is provided. The AMOLED panel has a plurality of pixel units and the temperature sensor is used for measuring the temperature of the AMOLED panel. In addition, the feedback control circuit can adjust the driving current of the AMOLED panel according to the temperature. In the present invention, the feedback control circuit is capable of controlling the driving current of the pixel array to be inversely proportional to the temperature measured by the temperature sensor.

According to another aspect of the present invention, a method of controlling an AMOLED panel is provided. First, a temperature sensor is used to measure the temperature of at least a portion of the area of the AMOLED panel and transmit the result of the measurement to a feedback control circuit. Then, the feedback control circuit adjusts the driving current of the AMOLED panel according to the temperature in such a way that the driving current of the AMOLED panel is inversely proportional to the temperature.

The present invention uses a temperature sensor to measure the temperature of the AMOLED panel. Furthermore, a feedback control circuit is used to adjust the driving current of the AMOLED panel according to the temperature such that the driving current is inversely proportional to the temperature. Hence, any rise in the temperature of the AMOLED panel will lower the conducting current of the organic light emitting diodes and thereby increase in the lifetime of the panel.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a graph showing the variation of the driving current of a conventional display panel at different temperatures.

FIG. 2 is a circuit diagram of an active matrix organic light emitting flat panel display according to one preferred embodiment of the present invention.

FIG. 3 is a circuit diagram of a pixel unit according to one preferred embodiment of the present invention.

FIG. 4 is a graph showing the variation of the driving current of a display panel at different temperatures according to the present invention.

FIG. 5 is a circuit diagram of an active matrix organic light emitting flat panel display according to another preferred embodiment of the present invention.

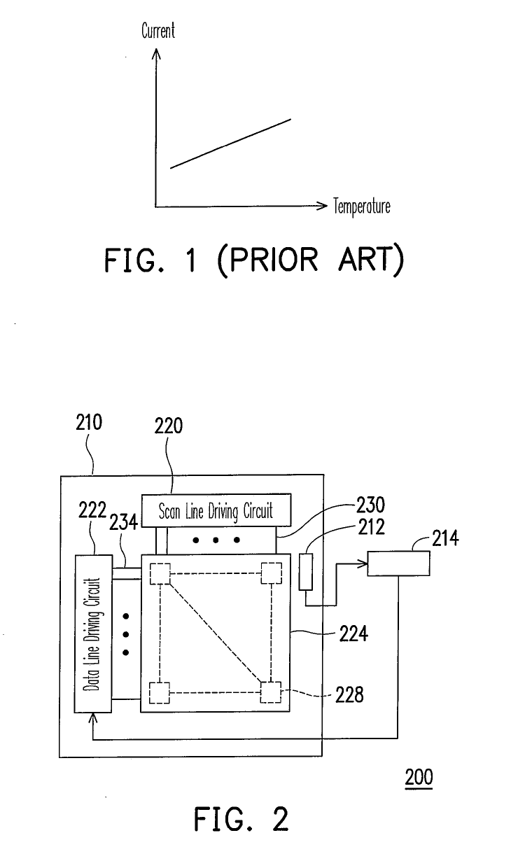

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a circuit diagram of an active matrix organic light emitting flat panel display according to one preferred embodiment of the present invention. As shown in FIG. 2, the present invention provides a flat panel display 200 comprising an AMOLED panel 210, a temperature sensor 212 and a feedback control circuit 214. The temperature sensor 212 is disposed on the AMOLED panel 210 for measuring the temperature when the AMOLED panel 210 is in operation and transmitting this information to the feedback control circuit 214. In one embodiment, the temperature sensor 212 and the feedback control circuit 214 can be integrated into the AMOLED panel 210.

The AMOLED panel 210 includes a scan line driving circuit 220, a data line driving circuit 222 and a pixel array 224. The pixel array 224 has a plurality of pixel units 228 arranged in an array. The scan line driving circuit 220 is coupled to the pixel array 224 through a plurality of scan lines 230. Similarly, the data line driving circuit 222 is coupled to the pixel array 224 through a plurality of data lines 234.

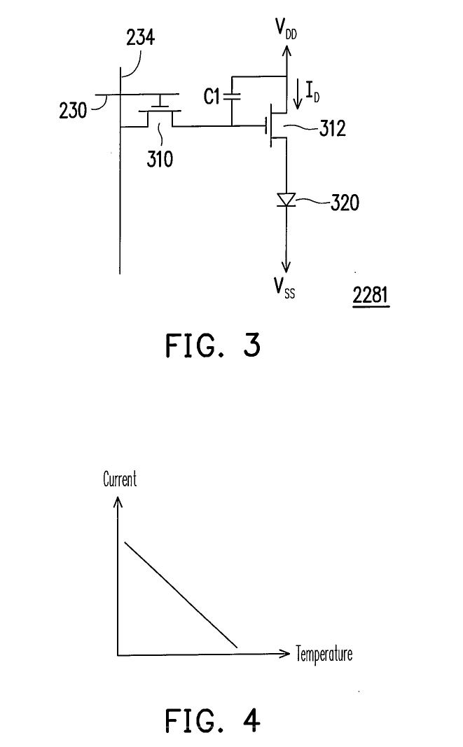

FIG. 3 is an explanatory circuit diagram of a pixel unit according to one preferred embodiment of the present invention. The explanatory circuit is suitable for the pixel unit 228 in FIG. 2. As shown in FIG. 3, the pixel unit 2281 comprises a transistor 310, a transistor 312 and an organic light emitting diode 320. In the present embodiment, the transistors 310 and 312 can be implemented using NMOS transistors or PMOS transistors. The transistor 310 has a gate terminal coupled to a scan line 230, a source terminal coupled to a data line 234 and a drain terminal coupled to a gate terminal of the transistor 312. On the other hand, the transistor 312 has a source terminal coupled to a working voltage V_{DD}, and coupled to the gate terminal of the transistor 312 through a capacitor C1, a drain terminal coupled to the anode of the organic light emitting diode 320. Furthermore, the organic light emitting diode 320 is coupled to a common voltage V_{SS} through the cathode. In the embodiment of the present invention, the common voltage V_{SS} can be a ground potential.

As shown in FIG. 2, the scan line driving circuit 220 is used for generating scan signals and the data line driving circuit 222 is used for generating data voltages. To drive the pixel unit 2281 in FIG. 3, the scan line driving circuit 220 enables the scan signal on the scan line 230 so that the transistor 310 is conductive. At this moment, the data line driving circuit 222 outputs a data voltage signal. The data voltage signal is transmitted to the pixel unit 2281 through the data line 234 and then transmitted to the gate of the driving transistor 312 through the transistor 310. Thus, the transistor 312 is activated and a driving current I_{D} is generated to drive the organic light emitting diode 320.

As shown in FIG. 3, the driving current I_{D}, the data voltage, the working voltage and the common voltage are all related. This particular characteristic is utilized to adjust the driving current in the present invention.

As shown in FIG. 2, the temperature of the AMOLED panel 210 will continue to gradually rise with longer period of operation. If the temperature sensor 212 measures a rise in temperature in a portion of the pixel units in the AMOLED panel 210, the feedback control circuit 214 will lower the voltage through the data line driving circuit 222. In the meantime, the voltage at the gate terminal of the transistor 312 is also reduced so that the operating voltage of the transistor 312 is lowered. With a lowering of the operating voltage of the transistor 312, a smaller driving current I_{D} is generated by the transistor 312 so that the driving current I_{D} passing through the light emitting diode is reduced.

FIG. 4 is a graph showing the variation of the driving current of a display panel at different temperatures according to the present invention. As shown in FIGS. 2 and 4, the feedback control circuit 214 in FIG. 2 controls the driving current of the AMOLED panel according to the temperature of an area measured by the temperature sensor 212. The driving current is adjusted so that it is inversely proportional to the temperature of the measured area. Therefore, when the temperature of the AMOLED panel rises, the driving current I_{D} is lowered to reduce the aging of the AMOLED panel 210, thereby extending the lifetime of the AMOLED panel.

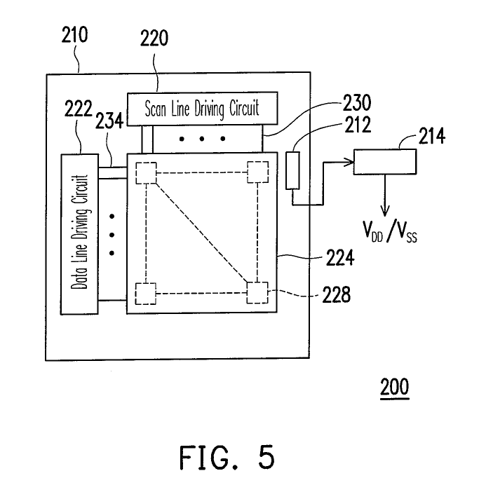

FIG. 5 is a circuit diagram of an active matrix organic light emitting flat panel display according to another preferred embodiment of the present invention. As shown in FIG. 5, the present invention provides a flat panel display 200 comprising an AMOLED panel 210, a temperature sensor 212 and a feedback control circuit 214. The temperature sensor is disposed on the AMOLED panel 210 for measuring the temperature of the AMOLED panel 210 in operation and transmitting the information to the feedback control circuit 214.

As shown in FIGS. 3 and 5, the temperature will continuously rise when the AMOLED panel is being operated for a time period. If the temperature sensor 212 detects a rise in temperature of a portion of the pixel units in the AMOLED panel 210, the feedback control circuit 214 will reduce the working voltage V_{DD} of the transistor 312. With a reduction in the working voltage V_{DD} of the transistor 312, the voltage difference between the working voltage V_{DD} and the common voltage VSS is reduced so that the driving current I_{D} generated by the transistor 312 is also reduced. As a result, the driving current I_{D} of the organic light emitting diode 320 is reduced to prevent a hastening of the aging of the AMOLED panel 210 and extend the lifetime of the panel.

In addition, if the temperature sensor 212 detects a rise in temperature of a portion of the pixel units of the AMOLED panel 210 after the AMOLED panel 210 is being operated for a period of time, the feedback control circuit 214 in the present invention can be used to lower the driving current I_{D} by adjusting the common voltage V_{SS} of the pixel unit 2281. As shown in FIG. 3, the voltage difference between the working voltage V_{DD} and the common voltage V_{SS} can be reduced by adjusting the potential of the common voltage V_{SS} under a fixed working voltage V_{DD} condition. Therefore, the driving current I_{D} generated by the transistor 312 will be reduced. With a reduction in the driving current I_{D} passing through the organic light emitting diode 320, the aging of the AMOLED panel 210 may be reduced.

In summary, the present invention uses a temperature sensor to measure the temperature of the AMOLED panel and a feedback control circuit to adjust the driving current of the AMOLED panel according to the temperature such that the driving current is inversely proportional to the temperature. Hence, any rise in the temperature of the AMOLED panel will lower the conducting current of the organic light emitting diodes so that the aging of the AMOLED panel may be reduced to increase its lifetime.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flat panel display, comprising:
an active matrix organic light emitting diode (AMOLED) panel having a plurality of pixel units arranged in an array;
a temperature sensor for measuring a temperature of the AMOLED panel; and
a feedback control circuit for adjusting a driving current of the AMOLED panel according to a temperature measured by the temperature sensor so that the driving current of the AMOLED panel is inversely proportional to the temperature.

2. The flat panel display of claim 1, wherein each pixel unit comprises:
a first transistor having a source terminal for receiving a data voltage and a gate terminal for receiving a scan signal;
a second transistor having a source terminal coupled to a working voltage and a gate terminal coupled to a drain terminal of the first transistor and coupled to the source terminal of the second transistor through a capacitor; and
an organic light emitting diode having an anode coupled to a drain terminal of the second transistor and a cathode coupled to a common voltage.

3. The flat panel display of claim 2, wherein the first transistor and the second transistor comprises NMOS transistors or PMOS transistors.

4. The flat panel display of claim 2, wherein the feedback control circuit adjusts the working voltage to control the driving current according to the temperature measured by the temperature sensor.

5. The flat panel display of claim 2, wherein the feedback control circuit adjusts the data voltage to control the driving current according to the temperature measured by the temperature sensor.

6. The flat panel display of claim 2, wherein the common voltage has a ground potential.

7. The flat panel display of claim 2 wherein the feedback control circuit adjusts the common voltage to control the driving current according to the temperature measured by the temperature sensor.

8. A method of controlling an active matrix organic light emitting diode (AMOLED) panel, comprising:
measuring a temperature of at least a portion of an area of the AMOLED panel to generate a resulting measurement, and
adjusting a driving current of the AMOLED panel according to the resulting measurement such that the driving current of the AMOLED panel is inversely proportional to the temperature of the measured area.

9. The method of controlling the AMOLED panel of claim 8, wherein the step of adjusting the driving current of the AMOLED panel comprises adjusting a working voltage of the AMOLED panel so that the driving current of the AMOLED panel is inversely proportional to the temperature of the measured area.

10. The method of controlling the AMOLED panel of claim 8, wherein the step of adjusting the driving current of the AMOLED panel comprises adjusting a data voltage for driving the AMOLED panel so that the driving current of the AMOLED panel is inversely proportional to the temperature of the measured area.

11. The method of controlling the AMOLED panel of claim 8, wherein the step of adjusting the driving current of the AMOLED panel comprises adjusting a common voltage for driving the AMOLED panel so that the driving current of the AMOLED panel is inversely proportional to the temperature of the measured area.
